(19) United States
(12) Patent Application Publication
(10) Pub. No.: US 2006/0190582 A1
(43) Pub. Date: Aug. 24, 2006

(54) Maintaining building serviceability information for geographic locations

(76) Inventors: David A. Fry, Lake Forest, CA (US); William Thomas Prescott, Mission Viejo, CA (US)

Correspondence Address: MERCHANT & GOULD PC, P.O. BOX 2903, MINNEAPOLIS, MN, 55402-0903, US

(21) Appl. No.: 11/283,439

(22) Filed: Nov. 18, 2005

Related U.S. Application Data
(60) Provisional application No. 60/629,721, filed on Nov. 19, 2004.

(51) Int. Cl. G06F 15/173

(52) U.S. Cl. 709/223

(57) ABSTRACT

Systems and methods are disclosed for maintaining building serviceability information for geographic locations. The disclosed systems and methods may include receiving a request for communication services information for a geographic location, wherein a user enters location information specific to the geographic location into a communications service management system. Furthermore, the disclosed systems and methods may include receiving medium information about the geographic location from the communications service management system and determining which communications services are currently provided to the geographic location. Moreover, the disclosed systems and methods may include displaying the communications services that are currently provided to the geographic location to the user.

### RELATED APPLICATION

Under provisions of 35 U.S.C. §119(e), the Applicants claim the benefit of U.S. provisional application no. 60/629,721, filed Nov. 19, 2004, which is incorporated herein by reference.

### BACKGROUND

I. Field of the Invention

The present invention generally relates to methods and systems for maintaining building serviceability information for geographic locations. More particularly, the present invention relates to maintaining building serviceability information for geographic locations or that, for example, can be provided to a particular geographic location.

II. Background Information

Maintaining building serviceability information for geographic locations is a process for maintaining information about communications services (services) associated with buildings and structures in a city. In many situations, maintaining service information is quite cumbersome. For example, a city may have thousands of buildings within its limits. Thus, the conventional strategy is to maintain service information in a spreadsheet or database. This often causes problems because the conventional strategy does not lend itself to quick retrieval of service information. For example, a customer representative of a communication company may need to retrieve service information quickly when responding to an inquiry from a customer.

In view of the foregoing, there is a need for methods and systems for maintaining building serviceability information for geographic locations more optimally. Furthermore, there is a need for maintaining building serviceability information for geographic locations that may be used by multiple departments with a communications company and reflect updates to service information in the system immediately.

### SUMMARY OF THE INVENTION

Consistent with embodiments of the present invention, systems and methods are disclosed for maintaining building serviceability information for geographic locations.

In accordance with one embodiment, a method of maintaining communication services information for geographic locations may comprise receiving a request for communication services information for a geographic location, wherein a user enters location information specific to the geographic location into a communications service management system, receiving medium information about the geographic location from the communications service management system, determining which communications services are currently provided to the geographic location, and displaying the communications services that are currently provided to the geographic location to the user.

According to another embodiment, a computer-readable medium which stores a set of instructions which when executed performs a method for maintaining communication services information for geographic locations, the method executed by the set of instructions comprising receiving a request for communication services information for a geographic location, wherein a user enters location information specific to the geographic location into a communications service management system, receiving medium information about the geographic location from the communications service management system, determining which communications services are currently provided to the geographic location, and displaying the communications services that are currently provided to the geographic location to the user.

In accordance with yet another embodiment, a computer-readable medium which stores a set of instructions which when executed performs a method for maintaining communication services information for geographic locations, the method executed by the set of instructions comprising receiving a request for communication services information for a geographic location, wherein a user enters location information specific to the geographic location into a communications service management system, receiving medium information about the geographic location from the communications service management system, determining which communications services are currently provided to the geographic location, determining which communications services can be provided to the geographic location based on the medium information for the geographic location, and displaying the communications services that are currently provided to the geographic location to the user and the communications services that can be provided to the geographic location to the user.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a diagram illustrating exemplary system modules for the present invention, according to one embodiment.

FIG. 2 is a screen view illustrating an exemplary building information module, according to one embodiment.

FIG. 3 is a screen view illustrating an exemplary access module, according to one embodiment.

FIG. 4 is a screen view illustrating an exemplary construction module, according to one embodiment.

FIG. 5 is a screen view illustrating an exemplary sales module, according to one embodiment.

FIG. 6 is a diagram illustrating an exemplary system architecture, according to one embodiment.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding stages to the disclosed methods. Accordingly, the following detailed description does not limit the invention. Instead, the proper scope of the invention is defined by the appended claims.

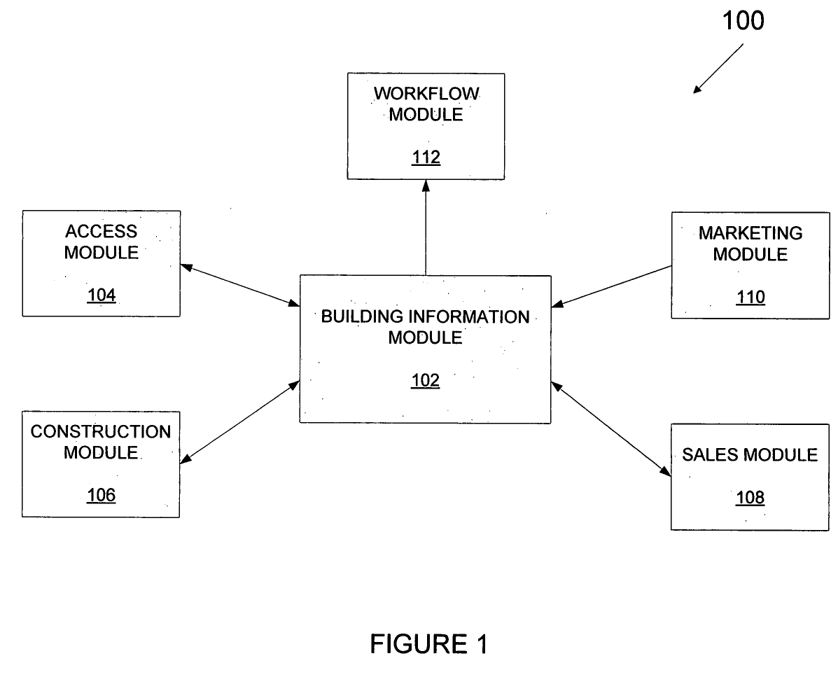

FIG. 1 illustrates an exemplary diagram 100 of system modules for the present invention, according to one embodiment. The diagram 100 can include a building information module 102, an access module 104, a construction module 106, a sales module 108, a marketing module 110, and a workflow module 112. The access module 104, construction module 106, sales module 108 and marketing module 110 can be maintained by individuals within a department associated with each system module. Therefore, each department can update and modify information specific to the department. Depending on the information updated or modified, the access module 104, construction module 106, sales module 108 and marketing module 110 sends the information to the building information module 102.

The access module 104 exchanges information with the building information module 102 regarding a company's access right for a given geographic location. The construction module 106 exchanges information with the building information module 102 regarding the company's construction projects for a given geographic location. The sales module 108 exchanges information with the building information module 102 regarding existing services for customers, upcoming services available to customers and status information for services sold to customers by a salesman. The marketing module 110 exchanges information with the building information module 102 regarding products and services available to customers for a given geographic location.

While an individual department may have access to information within that group, other groups may be interested in information about a given geographic location associated with other departments. Accordingly, the workflow module 112 provides a synopsis of information assembled from the access module 104, construction module 106, and sales module 108 for a given geographic location. Thus, the workflow module 112 may be used to exchange information between departments, or assist in providing information about a given geographic location promptly when dealing with customer service matters.

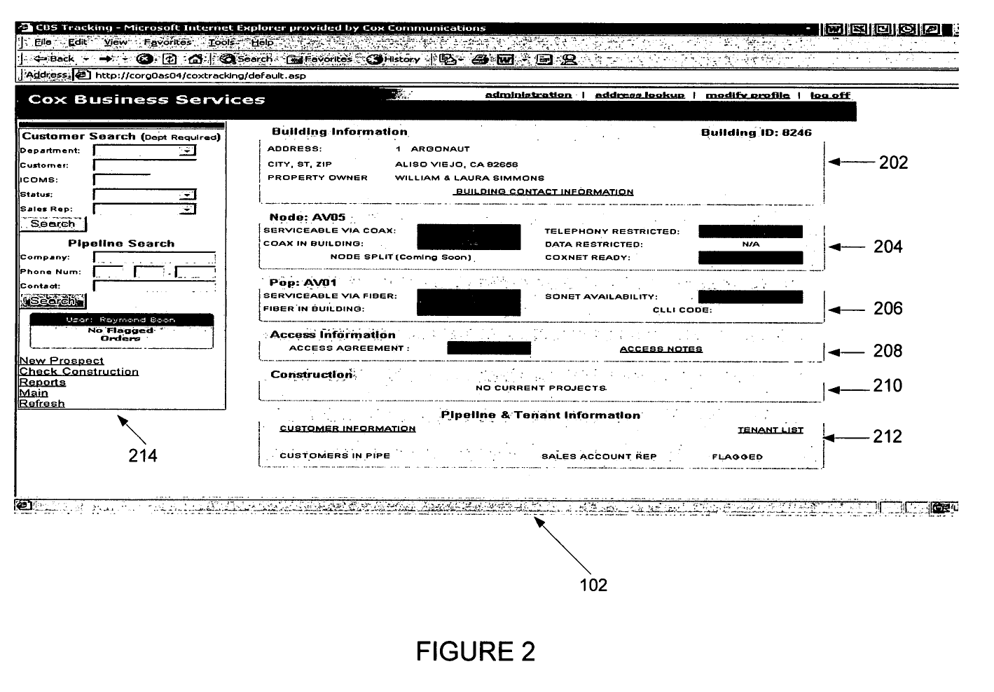

FIG. 2 is a screen view illustrating an exemplary building information module 102, according to one embodiment. The building information module 102 includes a building information subsection 202, a node information subsection 204, a point-of-presence (POP) information subsection 206, an access information subsection 208, a construction information subsection 210, a tenant information subsection 212, and a customer search subsection 214. The building information module 102 maintains information about a given geographic location concerning a company's current services, potential services available to the given geographic location, access rights, general communications information for the given geographic location and general customer information.

Each geographic location can be associated with a street address. If multiple buildings are associated with a particular street address, other identification information can be utilized, for example, a building identification number (building ID), to distinguish the company's building identification information for the street address.

Associated with each street address is communications infrastructure information about communications mediums present within a building at the street address. For example, the building may use copper, coaxial, fiber optics or wireless mediums to support communications within the building. Also, associated with each street address is infrastructure information about communications services available to the building. For example, coaxial services (node service) may be available to a building at a particular street address, or fiber optic services (POP service) may be available to a building at a particular street address. Such information is valuable to salesmen when interacting with customers who are seeking new or expanded service from the company. A salesman can view services available to a particular street address based on the communications infrastructure leading to the building using service information from the building information module 102 and offer the appropriate services to the customer.

Using the building information module 102, building information can be displayed using color codes to indicate the availability of services for a street address, access rights to a building, or progress on projects associated with a given street address. In addition, the customer search subsection 214 may be used by company representatives for obtaining information about a street address when communicating with a customer.

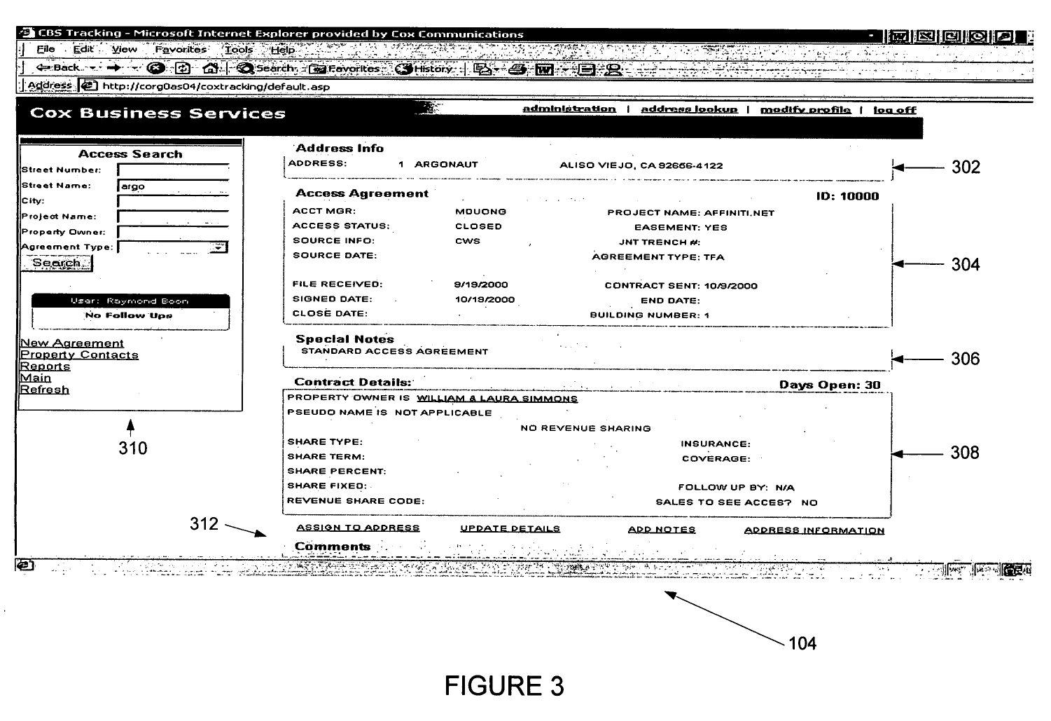

FIG. 3 is a screen view illustrating an exemplary access module 104, according to one embodiment. The access module 104 can include an address information subsection 302, an access agreement subsection 304, a special notes subsection 306, a contract detail subsection 308, an access search subsection 310, and a comments subsection 312. The access module 104 maintains information about access rights for a given geographic location.

When providing services to a particular street address, the company may be subject to various access limitations by owners of a building at the street address, for example, service technicians may only enter the building through the loading dock entrance. Failure to adhere to such requirements may subject the company to legal ramifications. Accordingly, it is imperative that access information is maintained by the company for the buildings in which the company provides service and the access information be maintained in a manner which promotes prompt access to such information.

The access agreement subsection 304 provides access information for the street address listed in the address information subsection 302. For example, the company may be afforded full access to a building allowing the company to service the building by assessing all parts of the building necessary for completing a given task. The company may have an easement agreement with a particular building thereby limiting access to the building by technicians. The company may have a common area agreement associated with an address having multiple building giving access right to technicians only to common areas. The special notes subsection 306 may also be used in conjunction with the access agreement subsection 304 to provide additional information about the access rights of the company for a particular building, for example, technicians are only to enter the building using the side entrance.

The contract detail subsection 308 can be used to maintain relevant information about a particular access agreement. The comments subsection 312 can be used to provide additional information or comments by employees in the access department of the company about an access agreement. In addition, the access search subsection 310 may be used by the access department to provide information about access rights for a given location to technicians.

Access agreement information may be used by the access department to provide a penetration report indicating the company's presence within a given location; for example, the company has access to 70% of all buildings downtown. Accordingly, the penetration report may be used by the company to focus sales and services initiatives. When the status of an access agreement changes or is created, the access module 104 updates the building information module 102 with the new information. Accordingly, all departments of the company are apprised of the status change.

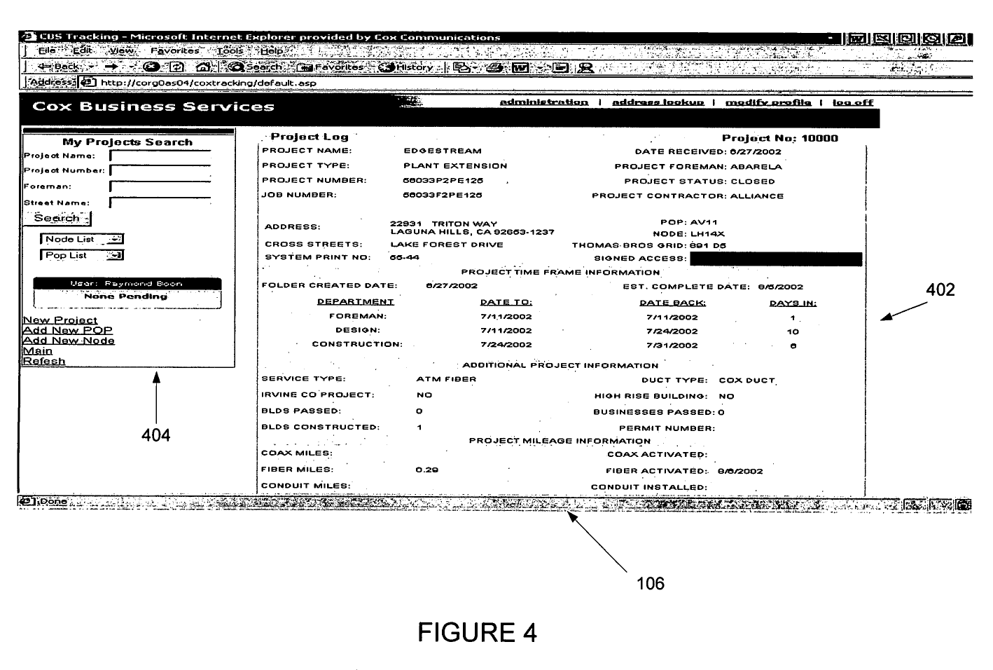

FIG. 4 is a screen view illustrating an exemplary construction module 106, according to one embodiment. The construction module 106 can include a project log subsection 402 and a project search subsection 404. The construction module 106 maintains information about a given geographic location regarding construction projects associated with the geographic location.

A company may conduct construction projects for a street address for a variety of reasons. For example, a POP has been expanded and is now available to service a building if the building is connected to the POP. Most construction projects are customer driven; however, construction projects may be instituted by the company in order to provide services to new and existing customers.

The project log subsection 402 may allow a construction department of the company to manage on-going construction projects as well as implementing new construction projects. The project log subsection 402 provides information about a construction project indicating what type of construction is being performed, status information, project leader information, street address and access rights among other things. The project log subsection 402 can also include information about project construction timetables. The project log subsection 402 can also include additional project information as well as information regarding resources used in the construction project.

In addition, the projects search subsection 404 may be used by the construction department to obtain information about certain projects for management and accounting purposes. By using construction module 106, the construction department for the company can manage construction and maintain up to date information about a particular project. Thus, the construction department can view and update project lifecycle information for all construction projects. With such information available, construction managers may tailor construction projects to specific needs associated with a particular building or geographic location.

In addition, the construction module 106 can also provide a “can we serve” option for determining if the company should institute a construction project without a customer request to create new sales opportunities. Geographic locations can be searched to determine if establishing new service in an area or expanding service for the geographic is economically feasible. Thus, unlike a standard construction project, the “can we serve” construction projects may be implemented by the construction department whenever a construction project is economically beneficial to the company. When the status of a construction project changes, or the construction project is completed, the construction module 106 updates the building information module 102 with the new status information. Accordingly, all departments of the company are apprised of the status change.

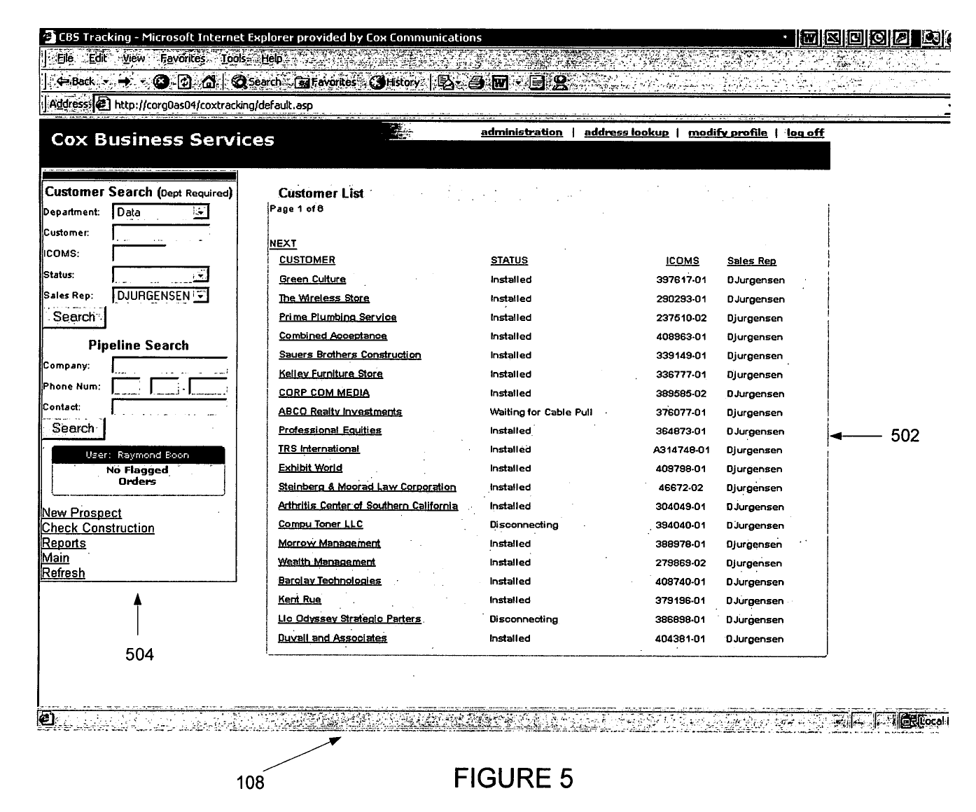

FIG. 5 is a screen view illustrating an exemplary sales module 108, according to one embodiment. The sales module 108 can include a customer subsection 502 and a customer search subsection 504. The sales module 108 maintains customer information for a given geographic location.

The customer subsection 502 allows the sales department of the company to view and update customer information and sales information, for example, which salesman sold services to a particular geographic location. Accordingly, the sales department can manage and update information regarding current customers, prospective customers and sales percentages. The customer search subsection 504 may be used by the sales department to obtain information about services and customers for a given a street address. When the status of a sale changes, the sales module 108 updates the building information module 102 with the new information. Accordingly, all departments of the company are apprised of the status change.

The marketing module 110 can be used by a marketing department of the company to provide product and service information to customers and other departments. The marketing module 110 provides a standardized listing of prices for products, services, bundling discounts and promotional discounts for a given location. When the status of a product, service, bundling discount or promotional discount changes, the marketing module 110 updates the building information module 102 with the new information. Thus, all individuals within the company have access to the same marketing information thereby reducing confusion and abuse of service promotions.

The workflow module 112 can be used by all departments to track information associated with a particular department or all information associated with a given geographic location. Thus, all departments are provided up to date information from all departments concerning building information, sales, construction or access. In addition, managers from each department can set up their individual modules, for example, sales, according to standards set for that particular department. Thus, the access module 104, the construction module 106, and the sales module 108 are dynamic and may be adapted to account for circumstances not currently addressed by the modules.

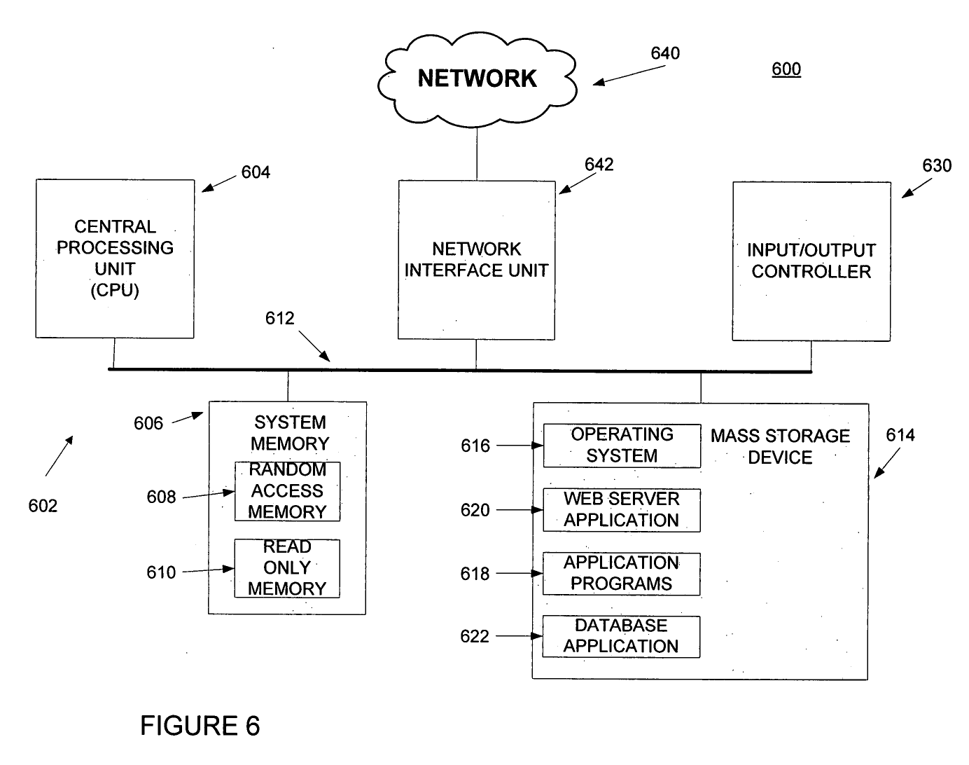

FIG. 6 is a diagram illustrating an exemplary system architecture 600, according to one embodiment. The following discussion regarding FIG. 6 is intended to provide a brief, general description of a suitable computing environment in which the invention may be implemented. While the invention will be described in the general context of program modules or applications running on an operating system of a server computer, those skilled in the art will recognize that the invention may also be implemented in combination with other program modules and applications.

Generally, program modules and applications include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices which are linked through a communications network. In a distributed computing environment, program modules may be located in both local and remote memory storage devices.

Thus, FIG. 6 provides an illustrative computer architecture 600 for a server computer 602 for practicing the various embodiments of the invention. The computer architecture 600 shown in FIG. 6 illustrates a conventional server computer 602, which can include a central processing unit 604 (“CPU”), a system memory 606, having a random access memory 608 (“RAM”), a read-only memory (“ROM”) 610, and a system bus 612 that couples the system memory 606 to the CPU 604. The server computer 602 further includes a mass storage device 614 for storing an operating system 616 and application programs 618.

The mass storage device 614 is connected to the CPU 604 through a mass storage controller (not shown) connected to the bus 612. The mass storage device 614 and its associated computer-readable media, provide non-volatile storage for the server computer 602. Although the description of computer-readable media contained herein refers to a mass storage device, such as a hard disk or CD-ROM drive, it should be appreciated by those skilled in the art that computer-readable media can be any available media that can be accessed by the server computer 602.

By way of example, and not limitation, computer-readable media may include computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the server computer 602 may operate in a networked environment using logical connections to remote computers through a network, such as the Internet. The server computer 602 may connect to the network 640 through a network interface unit 642 connected to the bus 612. It should be appreciated that the network interface unit 642 may also be utilized to connect to other types of networks and remote computer systems. The server computer 602 may also include an input/output controller 630 for receiving and processing input from a number of devices, including a keyboard or mouse (not shown). Similarly, the input/output controller 630 may provide output to a display screen, a printer, or other type of output device.

A number of program modules, applications, and data files may be stored in the mass storage device 614 and RAM 608 of the server computer 602, including an operating system 616 suitable for controlling the operation of a networked server computer 602. The mass storage device 614 and RAM 608 may also store one or more applications 618. The applications may be programmed in a variety of programming languages, for example, MICROSOFT.Net®.

The mass storage device 614 may also include a web server application 620 for providing web-based information such as on-line templates, chat rooms, hyperlinks, and information displays and demonstrations to the workstation computers linked to the server computer 602 over the network 640. The web server application 620 also provides a web-based interface for information exchange between a user and the server computer 602. An application component of the server computer 602 is a database application 622, for example, a Structured Query Language (SQL) database which is utilized to add, extract, route or modify information in the building information module 102, access module 104, construction module 106, sales module 108, marketing module 110, and workflow module 112.

While the term geographic location has been used throughout the application, any acceptable means for obtaining location information, for example, street address, longitude and latitude, or global position systems (GPS) may be utilized by the system architecture 600. Because the building information module 102, access module 104, construction module 106 and sales module 108 provide up to date information about company activities at a given geographic location, users from all departments are provided with project tracking capabilities using an associated module for their department or the workflow module 112.

Accordingly, the present invention may be used to obtain information about current services for a given location, mediums that exist within a building, sales information, construction information, access agreements for a given location and services available for sale at a given location. By having the ability to obtain information promptly, customer service is improved. In addition, management and department transparency is improved.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention may exist. Furthermore, although embodiments of the present invention have been described as being associated with data stored in memory and other storage mediums, aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering stages and/or inserting or deleting stages, without departing from the principles of the invention.

It is intended, therefore, that the specification and examples be considered as exemplary only, with a true scope and spirit of the invention being indicated by the following claims and their full scope of equivalents.

What is claimed is:

1. A method for maintaining communication services information for geographic locations, the method comprising:
receiving a request for communication services information for a geographic location, wherein a user enters location information specific to the geographic location into a communications service management system;
receiving medium information about the geographic location from the communications service management system;
determining which communications services are currently provided to the geographic location; and
displaying the communications services that are currently provided to the geographic location to the user.

2. The method of claim 1 further comprising entering service information for the geographic location into the communications service management system.

3. The method of claim 2, wherein department specific service information can be entered into the communications service management system by a user of the specific department of a company.

4. The method of claim 2, wherein the communications service information is information about access rights associated with the geographic location.

5. The method of claim 4 comprising tracking changes in access rights associated with the geographic location.

6. The method of claim 2 further comprising storing communications service information for the geographic location into a Structured Query Language database.

7. The method of claim 2, wherein the communications service information is information about construction projects associated with the geographic location.

8. The method of claim 7, wherein the information about construction projects is information associated with costs for one or more construction projects.

9. The method of claim 7, wherein a construction project associated with the geographic location is customized for the particular geographic location.

10. The method of claim 1, wherein the medium information is communications service infrastructure information associated with a structure at the geographic location.

11. The method of claim 1, wherein medium information is communications service infrastructure information within a structure at the geographic location.

12. The method of claim 1 further comprising determining which communications services can be provided to the geographic location based on the medium information for the geographic location and displaying the services that can be provided to the geographic location to the user.

13. The method of claim 12 further comprising obtaining cost information for the communications services which can be provided to the geographic location based on the medium information for the geographic location.

14. The method of claim 12 further comprising based on which communications services can be provided to the geographic location, determining which communications services are not in current use by a customer and offering for sale to the customer those communications services not in current use by the customer.

15. The method of claim 12 further comprising based on which communications services can be provided to the geographic location, determining whether a construction project should be implemented to add communications services to the geographic location.

16. The method of claim 1, wherein the geographic location may be associated with a street address, longitude and latitude or a GPS location.

17. The method of claim 1 further comprising tracking changes in communications services for the geographic location.

18. The method of claim 17 further comprising automatically updating the communications service management system with the changes in communications services for the geographic location.

19. A computer-readable medium which stores a set of instructions which when executed performs a method for maintaining communication services information for geographic locations, the method executed by the set of instructions comprising:
receiving a request for communication services information for a geographic location, wherein a user enters location information specific to the geographic location into a communications service management system;
receiving medium information about the geographic location from the communications service management system;
determining which communications services are currently provided to the geographic location; and
displaying the communications services that are currently provided to the geographic location to the user.

20. A computer-readable medium which stores a set of instructions which when executed performs a method for maintaining communication services information for geographic locations, the method executed by the set of instructions comprising:
receiving a request for communication services information for a geographic location, wherein a user enters location information specific to the geographic location into a communications service management system;
receiving medium information about the geographic location from the communications service management system;
determining which communications services are currently provided to the geographic location;
determining which communications services can be provided to the geographic location based on the medium information for the geographic location; and
displaying the communications services that are currently provided to the geographic location to the user and the communications services that can be provided to the geographic location to the user.
